(19) United States
(12) Patent Application Publication
(10) Pub. No.: US 2012/0182590 A1
(43) Pub. Date: Jul. 19, 2012

(54) AUTO DOCUMENT FEEDER AND DOCUMENT FEEDING METHOD

(75) Inventors: Seiji Iino, Kanagawa-ken (JP); Naoki Shoji, Kanagawa-ken (JP); Shoichi Taniguchi, Shizuoka-ken (JP); Osamu Kitazawa, Kanagawa-ken (JP); Akihito Tokutsu, Kanagawa-ken (JP); Shinji Miwa, Tokyo (JP); Mitsunori Ishii, Tokyo (JP); Takeshi Kojima, Shizuoka-ken (JP); Takeshi Ito, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/353,444

(22) Filed: Jan. 19, 2012

Related U.S. Application Data
(60) Provisional application No. 61/434,399, filed on Jan. 19, 2011.

(30) Foreign Application Priority Data
Jan. 17, 2012 (JP) 2012-7213

(51) Int. Cl. H04N 1/04

(52) U.S. Cl. 358/498

(57) ABSTRACT

An auto-document feeder includes a first image scanning section configured to scan an image on first side of a document, a paper feeding section configured to feed one by one the documents, from which images are read by the first image scanning section, a paper discharge section which discharges the document passed through the first image scanning section, plural conveying section which have different paths to reach the first image scanning section and which guide the document from the paper feeding section to the first image scanning section, a gate section which divides the document, which fed by the paper feeding section, to one of the plural conveying sections, a second image scanning section configured to scan the image on second side of a document, a jam detecting section which is located between the first image scanning section and the second image scanning section.

### CROSS-REFERENCE TO RELATED APPLICATIONS

This application is based upon and claims the benefit of priority from U.S. Provisional Application Ser. No. 61/434,399 filed on Jan. 19, 2011, and Japanese Patent Application No. 2012-7213 field on Jan. 17, 2012, the entire contents of both of which are incorporated herein by reference.

### FIELD

Described herein is an auto document feeding device which conveys a document to an image scanning device used in conjunction with a copy machine, printer, or the like that facilitates high-speed scanning.

### BACKGROUND

In an image scanning device such as a scanner used in an image forming apparatus such as a copy machine or printer, an increase in the image scanning speed is desired. Conventionally, there is a device in which plural document scanning conveying paths are formed and in which a scanning sensor for scanning the face-side image of the document and a scanning sensor for scanning the back-side image are provided in each conveying path, thereby increasing the scanning speed at the time of double-side scanning of the document images. An example of such an image scanning device includes a device having a first branch path through which a document is conveyed to a first scanning position, and a second branch path through which a document is conveyed to a second scanning position. Another example includes a device which has a scanner device and a CIS (contact image sensor) provided on the opposite sides of a first conveying path and simultaneously uses the scanner device and the CIS to scan both sides of a document conveyed on the first conveying path.

### BRIEF DESCRIPTION OF THE DRAWINGS

FIG. 1 is a configuration view schematically showing an image scanning device according to an embodiment;

FIG. 2 is a block diagram showing a control system of an ADP according to an embodiment;

FIG. 3 is a flowchart showing operations from turning on power to starting supply of a document according to an embodiment;

FIG. 4 is a flowchart showing operations to supply the document and convey the document to an OUT conveying member according to an embodiment;

FIG. 5 is a flowchart showing an operation to convey the document by using OUT conveying member according to an embodiment;

FIG. 6 is a flowchart showing operations from the start of scanning of an image to the end of scanning;

FIG. 7 is a flowchart showing an operation to convey a following document by using an IN conveying member according to an embodiment; and

FIG. 8 is a flowchart showing completion of the conveying according to an embodiment;

FIG. 9 is an explanatory view showing the state where the second sheet of the document is conveyed according to an embodiment; and

FIG. 10 is an explanatory view showing the distance between the first sheet and the second sheet of the document according to an embodiment.

### DETAILED DESCRIPTION

According to an embodiment, an auto-document feeder includes a first image scanning section configured to scan an image on first side of a document; a paper feeding section configured to feed the documents one by one, from which images are read by the first image scanning section; a paper discharge section which discharges documents passed through the first image scanning section; plural conveying sections which have different paths to reach the first image scanning section and which guide the documents from the paper feeding section to the first image scanning section; a gate section which directs the documents, which are fed by the paper feeding section, to one of the plural conveying sections; a second image scanning section configured to scan the image on second side of a document; and a jam detecting section which is located between the first image scanning section and the second image scanning section.

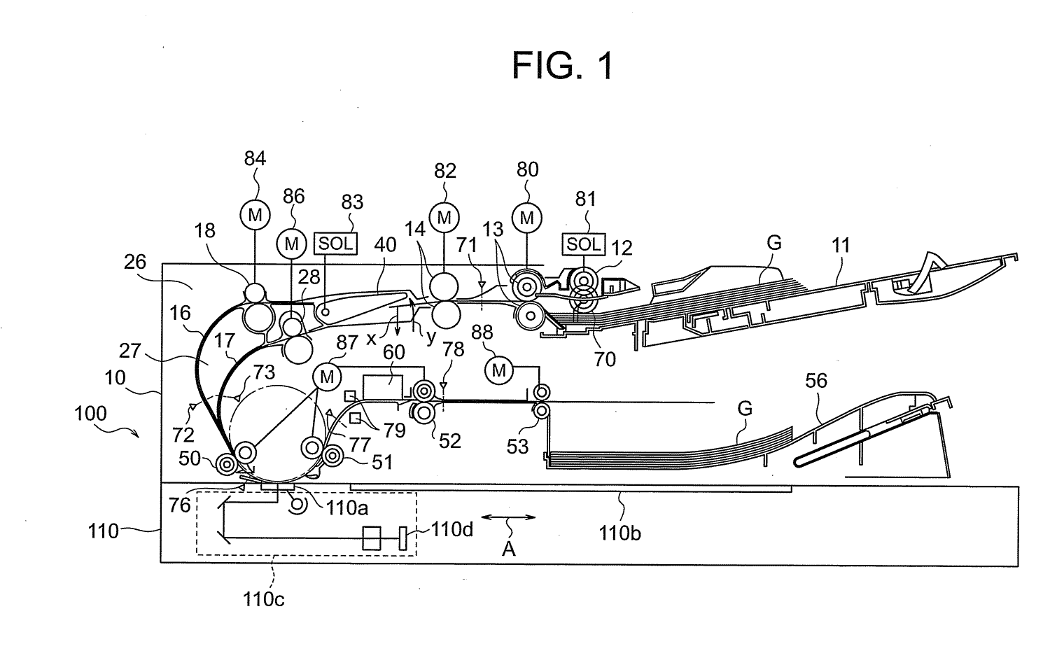

Hereinafter, an embodiment will be described. FIG. 1 shows an image scanning device 100 according to the embodiment. The image scanning device 100 has a scanner 110, which is an image scanning member, and an auto document feeding device (ADF) 10 which conveys a document G to the scanner 110. The scanner 110 has a READ document glass 110a and a platen glass 110b of a document setting table. The scanner 110 also has an optical mechanism 110c. The optical mechanism 110c optically scans an image of the document G traveling on the READ document glass 110a. Alternatively, the optical mechanism 110c is moved in the direction of arrow A (see FIG. 1) by a driving unit, not shown, along the platen grass 110b, and optically scans the image of the document G set on the platen glass 110b. The scanner 110 has a photosensor such as a CCD (charge coupled device) 110d which photoelectrically converts an optical signal from the optical mechanism 110c to an electric signal.

The auto document feeding device 10 has a document tray 11, which is a document stacking member, a pickup roller 12 which takes out the document G from the document tray 11, separation paper supply rollers 13 which prevent double feed of the document G, and registration rollers 14 which align the forward end of the document G taken out and conveyed from the document tray 11. The auto document feeding device 10 has two paths serving as conveying paths; namely, an OUT path 16 from the registration rollers 14 to the scanner 110, and an IN path 17 from the registration rollers 14 to the scanner 110. The OUT path 16, together with the document tray 11, the pickup roller 12, the separation paper supply roller 13 and the registration rollers 14, forms an OUT conveying member 26, as a first conveying member, for example. The IN path 17, together with the document tray 11, the pickup roller 12, the separation paper supply rollers 13 and the registration rollers 14, forms an IN conveying member 27, as a second conveying member, for example.

The OUT path 16 has intermediate OUT rollers 18. The IN path 17 has intermediate IN rollers 28. The auto document feeding device 10 has a gate 40 which directs the document G taken out from the document tray 11 and passed through the registration rollers 14, to the OUT path 16 or the IN path 17.

The auto document feeding device 10 has pre-scan rollers 50 which convey the document G passed through the OUT path 16 or the IN path 17 to the READ document glass 110a of the scanner 110, post-scan rollers 51 which discharge the document G from the READ document glass 110a, pre-discharge rollers 52, paper discharge rollers 53, and a paper discharge tray 56. The post-scan rollers 51, the pre-discharge rollers 52 and the paper discharge rollers 53 form a paper discharge member. A contact image sensor (CIS) 60, which is a second image scanning member, is provided between the post-scan rollers 51 and the pre-discharge rollers 52. This contact image sensor (CIS) 60 may be provided in a conveying path upstream of the paper discharge rollers 53.

On the READ document glass 110a, an image on the face side as a first side of the traveling document G is scanned. The CIS 60 scans an image on the back side as a second side of the traveling document G. Thus, it is possible to scan the images on both sides of the document G as a result of one pass of the document in the conveying path.

An empty sensor 70, which detects the presence or absence of the document G, is provided above the document tray 11. A registration sensor 71, which detects arrival of the document G at the registration rollers 14, is provided between the separation paper supply rollers 13 and the registration rollers 14. In the OUT path 16, a paper timing sensor OUT 72 as a first timing sensor, which detects the drive timing of the registration rollers 14 and the intermediate OUT rollers 18, is provided. In the IN path 17, a paper timing sensor IN 73 as a second timing sensor, which detects the drive timing of the registration rollers 14 and the intermediate IN rollers 28, is provided.

A pre-scan sensor 76 is provided between the pre scan rollers 50 and the READ document glass 110a. A scan sensor 77 and a double feed detection sensor 79 are provided between the post-scan rollers 51 and the pre-discharge rollers 52. A paper discharge sensor 78 is provided between the pre-discharge rollers 52 and the paper discharge rollers 53. In this embodiment, ultrasonic sensor is used as the double feed detection sensor 79.

A paper supply motor 80 drives the pickup roller 12 and the separation paper supply rollers 13 to rotate. The pickup roller 12 fluctuates by a pickup solenoid 81. A registration motor (RGT motor) 82 drives the registration rollers 14 to rotate. The gate 40 is switched by a gate solenoid 83. When the gate solenoid 83 is turned off, the gate 40 turns in the direction of arrow x and divides the document G to the OUT conveying member 26. When the gate solenoid 83 is turned on, the gate 40 turns in the direction of arrow y and divides the document G to the IN conveying member 27.

An intermediate OUT motor 84 drives the intermediate OUT rollers 18 to rotate. An intermediate IN motor 86 drives the intermediate IN rollers 28 to rotate. A READ motor 87 drives the pre-scan rollers 50, the post-scan rollers 51 and the pre-discharge rollers 52 to rotate. A paper discharge motor 88 drives the paper discharge rollers 53 to rotate.

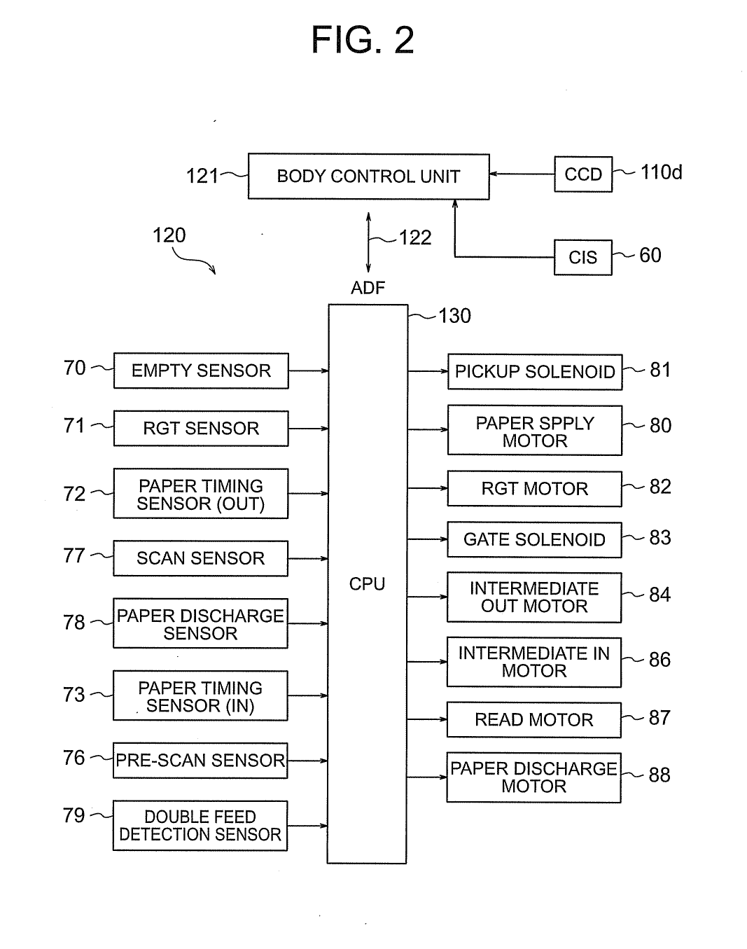

FIG. 2 shows a block diagram of a control system 120 for the ADF 10 and optionally other components. The CCD 110d of the scanner 110 and the CIS 60 are connected to a body control unit 121 which controls, for example, all or part of the image forming apparatus having the image scanning device 100. The body control unit 121 controls a CPU 130 of the ADF 10 via an input-output interface 122. The empty sensor 70, the registration sensor 71, the paper timing sensor OUT 72, the paper timing sensor IN 73, the pre-scan sensor 76, the scan sensor 77, the paper discharge sensor 78, and the double feed detection sensor 79 are connected to the input side of the CPU 130.

The pickup solenoid 81, the paper supply motor 80, the RGT motor 82, the gate solenoid 83, the intermediate OUT motor 84, the intermediate IN motor 86, the READ motor 87 and the paper discharge motor 88 are connected to the output side of the CPU 130.

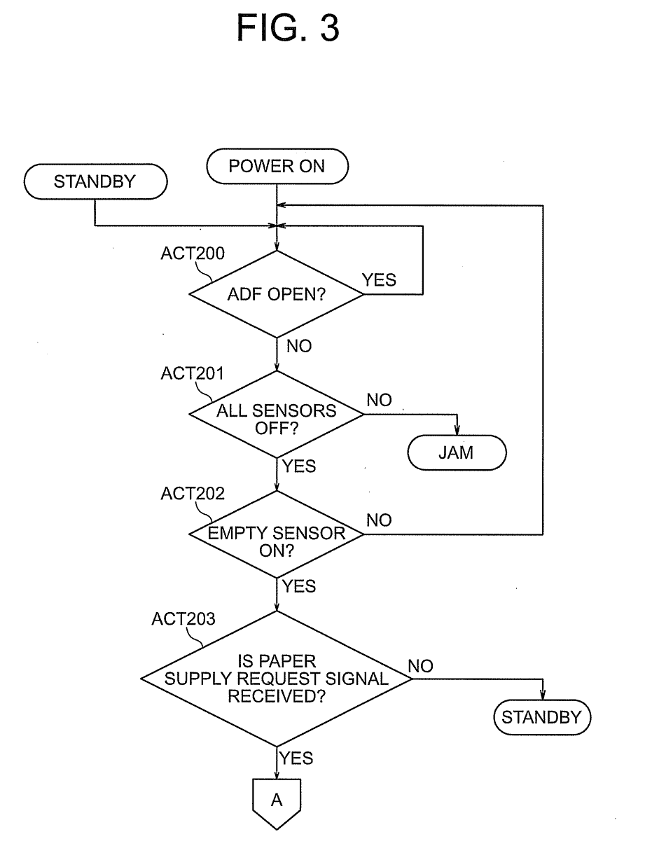

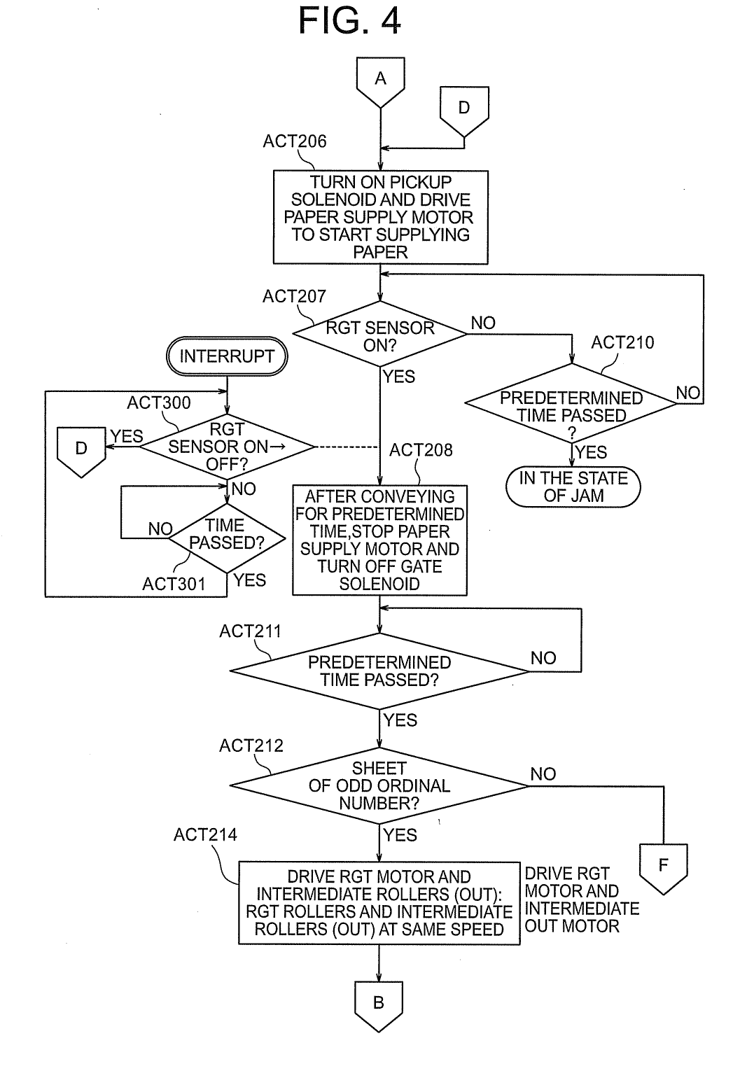

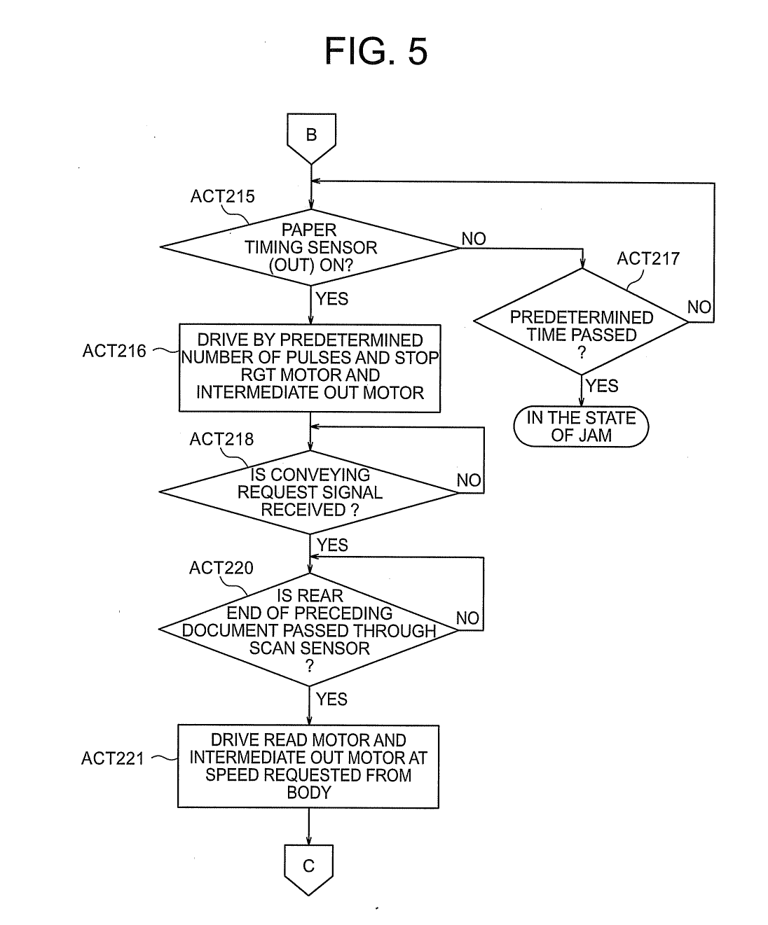

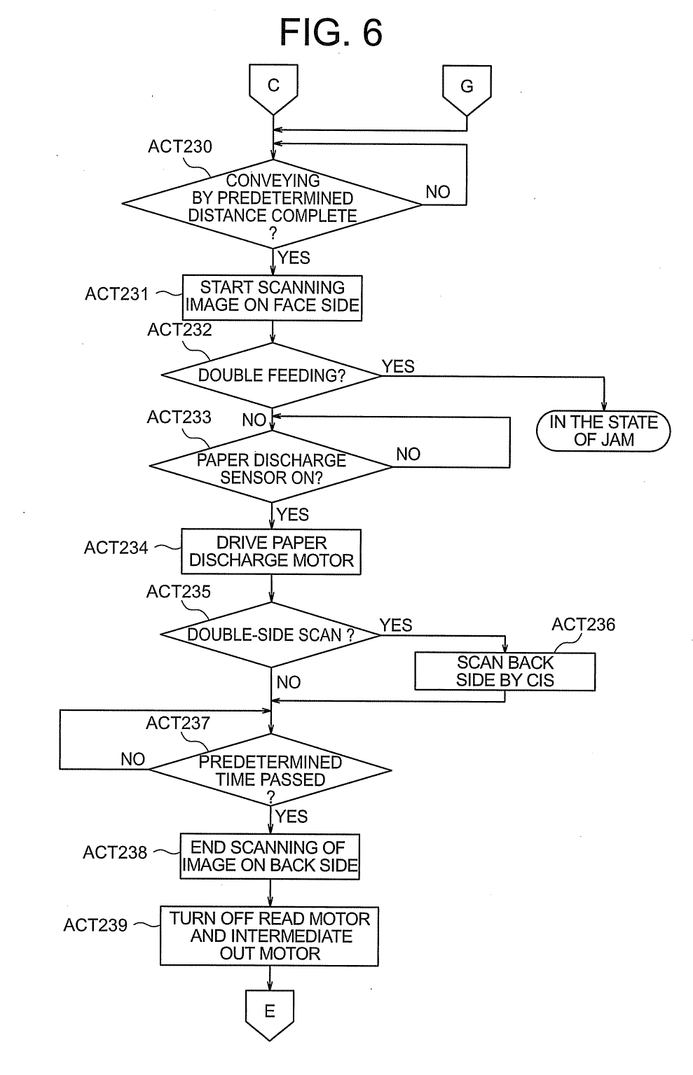

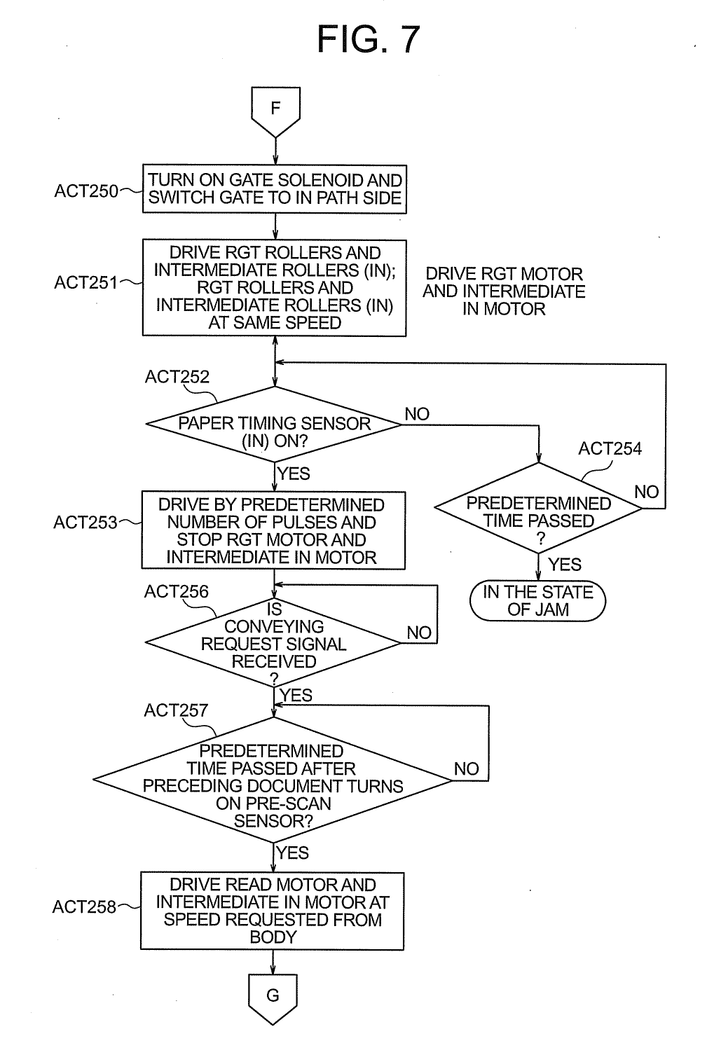

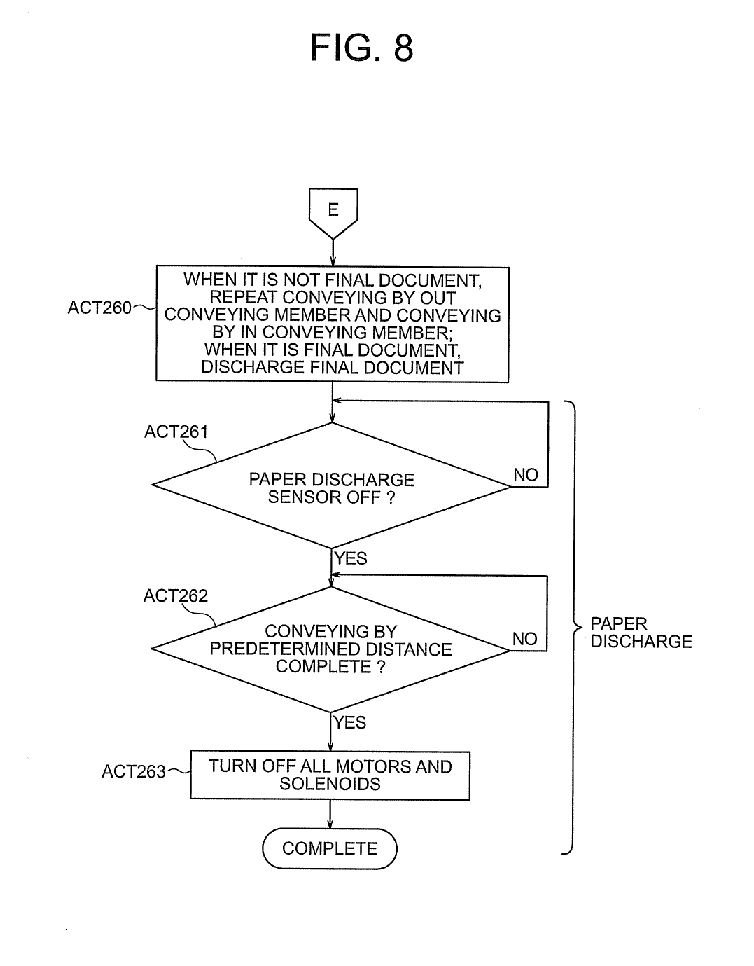

A process of continuously conveying the document G is described with reference to the flowcharts of FIG. 3 to FIG. 8. After power is turned on, it is confirmed in ACT 200 that the ADF 10 is closed. Detection of ?a jammed document? is conveyed out at all the sensors in ACT 201 to confirm that there is no jam of documents in the ADF 10 is closed. Detection of ? is conveyed out at all the sensors in ACT 201 to confirm that there is no jam of documents in the ADF 10. When the document G is set on the document tray 11 in ACT 202, the empty sensor 70 turns on and sends a document-on signal to the body control unit 121. After a paper supply request signal is received from the body control unit 121 in ACT 203, the processing goes to ACT 206.

In ACT 206, the pickup solenoid 81 is turned on and the paper supply motor 80 is turned on to rotate the pickup roller 12 and the separation paper supply rollers 13. Thus, supply of the document G1 as the first sheet (the first document G1) is started. When the registration sensor 71 turns on in ACT 207, the document G1 is conveyed for a predetermined time and then the paper supply motor 80 is turned off and the gate solenoid 83 is turned off (ACT 208). The first document G1 runs into the registration rollers 14 and its forward end is aligned and then the first document G1 stops. The gate 40 is set in the direction of dividing the first document G1 to the OUT conveying member 26. If the registration sensor 71 does not turn on even after the lapse of a predetermined time in ACT 210, it is determined that the document G1 causes a jam

When the registration sensor 71 turns on in ACT 207, the supply process of the document G2 as the second sheet (the second document G2) starts as an interrupt process, separately from and parallel to the conveying process of the first document G1. However, the supply process of the second document G2 stands by until the rear end of the first document G1 passes through the registration sensor 71. After the registration sensor 71 changes from on to off in ACT 300 (ACT 301), the processing goes to ACT 206 and supply of the second document G2 starts.

After a predetermined time passes in ACT 211 and the document G1 is a sheet of an odd ordinal number (ACT 212), the RGT motor 82 and the intermediate OUT motor 84 are turned on to rotate the registration rollers 14 and the intermediate OUT rollers 18 (ACT 214) respectively. The intermediate OUT rollers 18 are adjusted to the rotation speed of the registration rollers 14, and the registration rollers 14 and the intermediate OUT rollers 18 are rotated at a uniform velocity. The first document G1 is divided by the gate 40 and moves to the OUT conveying member 26.

When the paper timing sensor OUT 72 turns on in ACT 215, the RGT motor 82 and the intermediate OUT motor 84 are driven for a predetermined number of pulses and then stopped (ACT 216). The first document G1 stops before the pre-scan rollers 50. If the paper timing sensor OUT 72 does not turn on even after the lapse of a predetermined time in ACT 217, it is determined that the document G1 causes a jam.

After a conveying request signal is received from the body control unit 121 in ACT 218, the processing goes to ACT 220. When the scanner 110 can scan, the body control unit 121 sends a conveying request signal to the CPU 130. When there is preceding document G, and when passes a predetermined time after the forward end of the preceding document G turns on the pre-scan sensor 76 (ACT 220), the processing goes to ACT 221.

In ACT 221, the READ motor 87 and the intermediate OUT motor 84 are turned on to rotate the intermediate OUT motor 84 are turned on to rotate the intermediate OUT rollers 18, the pre-scan rollers 50, the post-scan rollers 51 and the pre-discharge rollers 52 at a speed according to an instruction from the body control unit 121. The timing when the rear end of the preceding document G passes the pre-scan rollers 50 and the timing when the forward end of the first document G1 starts conveying by the pre-scan rollers 50 are caused to coincide with each other. The first document G1 is conveyed to the READ document glass 110a in the state where the distance from the rear end of the preceding document G is reduced and approaches 0 mm.

After the first document G1 is conveyed by a predetermined distance (ACT 230), a scan start signal is sent to the body control unit 121. The body control unit 121 causes the scanner 110 to start scanning an image on the face side of the document G1 (ACT 231).

In parallel, when the rear end of the first document G1 passes through the registration sensor 71 and the registration sensor 71 changes from on to off, supply of the second document G2 is started in ACT 300. The first document G1 travels to the READ document glass 110a. The scanner 110 scans an image of the first document G1. The second document G2 runs into the registration rollers 14 and its forward end is aligned. And then the second document G2 stops.

To convey the second document G2 in parallel, when the registration sensor 71 turns on (ACT 207), the processing reaches ACT 212 via ACT 208 and ACT 211. In ACT 212, if the document G2 is a sheet of an even ordinal number, the processing goes to ACT 250. In ACT 250, the gate solenoid 83 is turned on and the gate 40 is thus switched to the direction to divide the second document G2 to the IN conveying member 27. Then, in ACT 251, the RGT motor 82 and the intermediate IN motor 86 are turned on to rotate the registration rollers 14 and the intermediate IN rollers 28. The intermediate IN rollers 28 are adjusted to the rotation speed of the registration rollers 14, and the registration rollers 14 and the intermediate IN rollers 28 are rotated at a uniform velocity. The second document G2 is divided by the gate 40 and moves to the IN conveying member 27.

In ACT 231, the first document G1 continues traveling on the READ document glass 110a and the scanner 110 continues scanning the image. The first document G1 is conveyed in the direction of the paper discharge rollers 53 via the post-scan rollers 51 and the pre-discharge rollers 52.

After the scanner 110 scans an image of the first document G1, the double feed detection sensor 79 determines whether double feeding or not (ACT 232). When the double feed detection sensor 79 detects double feeding, it is determined to be a jam.

For example, when overlap of the rear end of the preceding document G (the first document G1) and the forward end of the second document G2 is 5 mm or less, it is not necessary to determine the partial overlap as a double feeding of documents.

When the first document G1 turns on the paper discharge sensor 78 (ACT 233), the paper discharge motor 88 rotates the paper discharge rollers 53. In the case of a double-side scan (Yes in ACT 235), the processing goes to ACT 236. In ACT 236, an image on the back side of the first document G1 conveyed in the paper discharge direction is scanned by the CIS 60. When a predetermined time passes (ACT 237) after the paper discharge sensor 78 is turned on, image scanning on the face side of the first document G1 by the scanner 110 is finished (ACT 238). After the rear end of the document passes through the rollers 51, the READ motor 87 and the intermediate OUT motor 84 are turned off (ACT 239).

In parallel, with respect to the second document G2, when the paper timing sensor IN 73 is turned on in ACT 252, the RGT motor 82 and the intermediate IN motor 86 are driven by a predetermined number of pulses and then stopped (ACT 253). The second document G2 is stopped before the pre-scan rollers 50 in the IN conveying member 27. If the paper timing sensor IN 73 does not turn on, even after a predetermined time passes in ACT 254, it is determined that the document G1 causes a jam. After a conveying request signal for the second document G2 is received from the body control unit 121 in ACT 256, the processing goes to ACT 257.

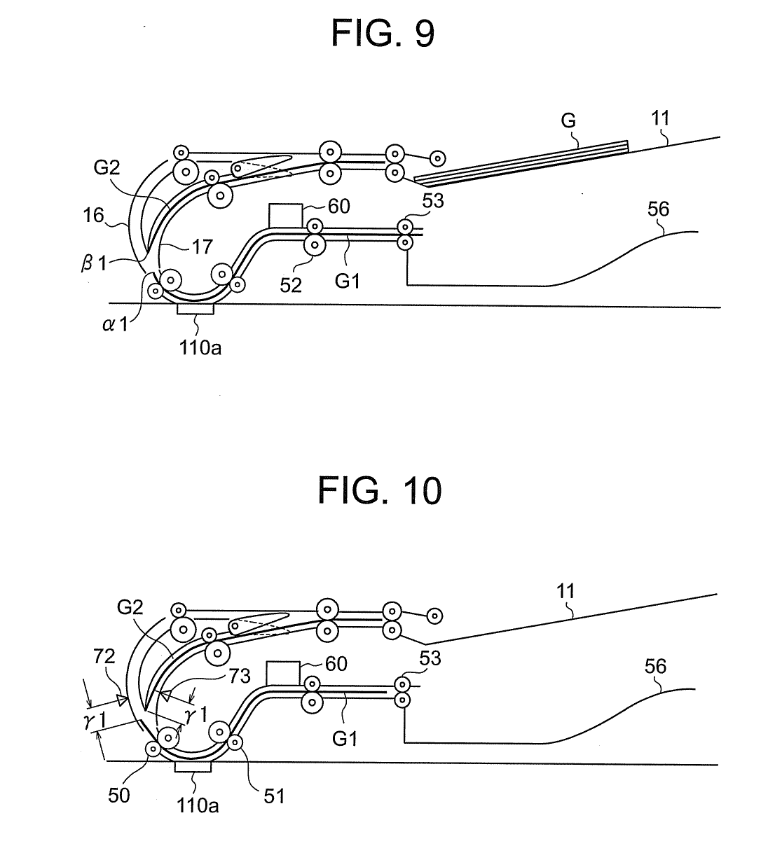

When a predetermined time passes after the forward end of the preceding document G (the first document G1) turns on the pre-scan sensor 76 in ACT 257, the processing goes to ACT 258. In ACT 258, the READ motor 87 and the intermediate IN motor 86 are turned on and the intermediate IN rollers 28, the pre-scan rollers 50, the post-scan rollers 51, and the paper discharge rollers 52 are rotated at a speed according to an instruction from the body control unit 121 (explain the beneficial effect that the controlled speed achieves). The point in time when the rear end of the preceding document G (the first document G1) passes the pre-scan rollers 50 and the point in time when the forward end of the second document G2 starts the conveying by the pre-scan rollers 50 are caused to coincide with each other. As shown in FIG. 9, the second document G2 is conveyed to the READ document glass 110a in the state where the distance between the rear end α1 of the preceding document G (the first document G1) and the forward end β1 of the second document G2 is reduced and approaches 0 mm.

To realize the state where the distance between the rear end α1 of the preceding document G (the first document G1) and the forward end β1 of the second document G2 is close to 0 mm, for example, the distance from the paper timing sensor OUT 72 to the pre-scan rollers 50 and the distance from the paper timing sensor IN 73 to the pre-scan rollers 50 are set to be equal. As shown in FIG. 10, after the paper timing sensor IN 73 is turned on, the second document G2 remains at a position advanced by a predetermined distance γ1. When the rear end of the preceding document G (the first document G1) passes through the paper timing sensor OUT 72 and advances by the predetermined distance γ1, the READ motor 87 and the intermediate IN motor 86 are turned on to convey the second document G2 in the direction of the READ document glass 110a. Thus, the distance between the rear end of the first document G1 and the forward end of the second document G2 can be made to approach 0 mm.

Alternatively, the timing of conveying the preceding document G1 (the first document G1) and the second document G2 can be adjusted in advance in accordance with the result of detection by the paper timing sensor OUT 72 and the result of detection by the paper timing sensor IN 73, thus realizing the state where the distance between the preceding document G (the first document G1) and the second document G2 is close to 0 mm.

The second document G2 conveyed to the READ document glass 110a after the preceding document G (the first document G1) in ACT 258 is conveyed by a predetermined distance (ACT 230) and then image scanning on the face side by the scanner 110 is started (ACT 231). In parallel, when the rear end of the second document G2 passes through the registration sensor 71 and the registration sensor 71 changes from on to off, supply of the document G3 as the third sheet (the third document G3) is started. The first document G1 is discharged in the direction of the paper discharge tray 56 by the paper discharge rollers 53. The second document G2 travels on the READ document glass 110a. The third sheet of the third document G3 runs into the registration rollers 14 and its forward end position aligned. And then the third document G3 stops.

To convey the third sheet of the document G3 in parallel, as the registration sensor 71 turns on (ACT 207), the processing reaches ACT 212 via ACT 208 and ACT 211. In ACT 212, if the third document G3 is a sheet of an odd ordinal number, the processing goes to ACT 214. In ACT 208, the gate solenoid 83 is turned off and the gate 40 is switched in the direction of dividing the third document G3 to the OUT conveying member 26. In ACT 214, the registration rollers 14 and the intermediate OUT rollers 18 are rotated to convey the third document G3 to the OUT conveying member 26. The first document G1 is set on the paper discharge tray 56. The second document G2 travels on the READ document glass 110a and turns on the paper discharge sensor 78. The third document G3 stops before the pre-scan rollers 50 in the OUT conveying member 26. After that, the third document G3 is conveyed to the READ document glass 110a in the state where the distance from the rear end of the preceding document G (the second document G2) is close to 0 mm.

When the document G is not the final document in a group of documents undergoing image processing, ACTs 214 to 221 (conveying of the document G by the OUT conveying member 26) and ACTs 250 to 259 (conveying of the document G by the IN conveying member 27) are alternately repeated and the documents are continuously conveyed in the state where the distance between any preceding document and the corresponding following document is close to 0 mm (ACT 260). When the document G is the final document and the paper discharge sensor 78 turns off (ACT 261), the final document is conveyed by a predetermined distance by the paper discharge rollers 53 (ACT 262). All the motors and solenoids are turned off (ACT 263). Then, conveying of the document by the ADF 10 is completed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An auto-document feeder comprising:
a first image scanning section configured to scan an image on first side of a document;
a paper feeding section configured to feed documents one by one, from which images are read by the first image scanning section;
a paper discharge section which discharges the documents passing through the first image scanning section;
plural conveying sections which have different paths to reach the first image scanning section and which guide the documents from the paper feeding section to the first image scanning section;
a gate section which directs the documents fed from the paper feeding section, to one of the plural conveying sections;
a second image scanning section configured to scan an image on second side of a document; and
a jam detecting section which is located between the first image scanning section and the second image scanning section.

2. The feeder according to claim 1, wherein the jam detecting section comprises an ultrasonic sensor.

3. The feeder according to claim 2, wherein the plural conveying sections include a first conveying section and second conveying section, and the gate section directs the document from the paper feeding section to one of the first conveying section and second conveying section in order.

4. The feeder according to claim 3, wherein the gate section alternately directs the document to the first conveying section or the second conveying section.

5. The feeder according to claim 3, wherein the first conveying section or second conveying section causes a following document to remain in the conveying section while a preceding document is scanned by the image scanning section.

6. The feeder according to claim 3, wherein the first conveying section or second conveying section coincides a point in time when a rear end of the preceding document passes the image scanning member and a point in time when a forward end of the following document reaches the image scanning section with each other.

7. The feeder according to claim 3, wherein the first conveying section has a first timing sensor which detects the document and the second conveying section has a second timing sensor which detects the document.

8. The feeder according to claim 7, wherein the first conveying section or the second conveying section detects a point in time when the rear end of the preceding document passes the image scanning section by using the first timing sensor or the second timing sensor, detects a point in time when the forward end of the following document reaches the image scanning section by using the first timing sensor or the second timing sensor, and coincides the point in time when the rear end of the preceding document passes the image scanning section and the point in time when the forward end of the following document reaches the image scanning section with each other.

9. A document feeding method comprising:
directing a document to one of plural conveying sections;
conveying the document directed to one of the plural conveying sections to a first image scanning section configured to scan an image of a first side of the document continuously, in order;
determining if a scanned document is in a jam; and
conveying the document passed through a detecting section to a second image scanning section configured to scan the image of a second side of the document.
